(19) United States
(12) Patent Application Publication
(10) Pub. No.: US 2019/0287155 A1
(43) Pub. Date: Sep. 19, 2019

(54) LANDING PAGE PROVIDING SERVER AND METHOD OF PROVIDING CUSTOMIZED LANDING PAGE

(71) Applicant: SK Planet Co., Ltd., Seongnam-si (KR)

(72) Inventor: Hyungyu PARK, Yongin-si (KR)

(21) Appl. No.: 16/351,188

(22) Filed: Mar. 12, 2019

(30) Foreign Application Priority Data
Mar. 13, 2018 (KR) 10-2018-0029392

(51) Int. Cl. G06Q 30/06; G06F 16/9535; G06F 16/2457

(52) U.S. Cl. CPC G06Q 30/0631; G06F 16/9535; G06F 9/547; G06Q 30/0641; G06F 16/24578

(57) ABSTRACT

The present disclosure provides a landing page providing server that provides a user-customized landing page and a method of providing the user-customized landing page. The landing page providing server according to an exemplary embodiment includes a behavioral log collection module configured to collect log information including a behavioral pattern of a user terminal connected to a shopping mall server; a recommendation engine module configured to analyze the behavioral pattern of the user terminal by using the log information collected by the behavioral log collection module and extracts recommended products suitable for the user terminal by using an analysis result; and a landing page generation module configured to make a landing page suitable for the user terminal to be generated based on the recommended products extracted by the recommendation engine module and to be provided to the shopping mall server.

### CROSS-REFERENCE TO RELATED APPLICATION

The present application claims priority to Republic of Korea Patent Application No. 10-2018-0029392 filed on Mar. 13, 2018, in the Korean Intellectual Property Office, which is incorporated herein in its entirety by reference.

### TECHNICAL FIELD

The present disclosure relates to a customized recommendation technique and, more particularly, to a service providing server and a method of providing a customized landing page for each user to maximize a marketing effect.

### BACKGROUND

With the developments of the mobile communications network and the upgrading of the terminal specification, a mobile communication terminal has become a necessity of the modern people beyond the scope of a simple communication device or information providing device and is evolving to a total entertainment device.

In a typical electronic commerce using a mobile communication terminal or a personal computer (PC), an online shopping mall provides a customer with information on products to be sold, and the customer checks details of the product and purchase a desired product. However, the customers have difficulties in finding their desired products on a large scale shopping mall which maintains lots of product information.

The difficulty in retrieving the products deteriorates satisfaction of the customers and their will to revisit. As a result, the electronic commerce providers are consistently seeking ways to effectively recommend products that the customers are likely to purchase.

In this regard, landing pages are getting attention and their importance is emerging in the electronic commerce service.

The landing page refers to a web page revealed by a web site to a user who accesses the web site via a search engine or various marketing campaigns.

Since a configuration or design of the landing page in a shopping mall significantly changes a conversion rate and a bounce rate, a landing page optimization (LPO) has become an important factor in the shopping mall.

However, the conventional method of configuring the landing page is usually very simple and their position is limited to web pages in the shopping mall such as a main page, product category pages, new product pages, specific product detail pages, event pages planned by the operator. Therefore, the conventional landing page has little effect on the conversion rate and the bounce rate.

### PRIOR ART REFERENCE

### Patent Literature

Korean patent No. 10-1040519 (Jun. 3, 2011)

### SUMMARY

Provided are a landing page providing server and a method of providing a landing page which can generate a landing page customized to each user to increase a conversion rate and lower a bounce rate of a site.

More specifically, one object of the present disclosure is to provide a real-time user-customized landing page by analyzing a behavioral pattern of a user of a user terminal and constructing the landing page by using an analysis result of the behavioral pattern of the user.

Additional aspects will be set forth in part in the description which follows and, in part, will be apparent from the description, or may be learned by practice of the presented exemplary embodiments.

According to an aspect of an exemplary embodiment, provided is a landing page providing server suitable for providing a user-customized landing page. The landing page providing server includes: a behavioral log collection module configured to collect log information including a behavioral pattern of a user terminal connected to a shopping mall server; a recommendation engine module configured to analyze the behavioral pattern of the user terminal by using the log information collected by the behavioral log collection module and extracts recommended products suitable for the user terminal by using an analysis result; and a landing page generation module configured to make a landing page suitable for the user terminal to be generated based on the recommended products extracted by the recommendation engine module and to be provided to the shopping mall server.

The landing page providing server may further include an on-sale products collection module configured to collect information on products sold by the shopping mall server in real-time or periodically.

The behavioral log collection module may collect, from the user terminal, the log information including at least one of behavioral patterns including: searching a product, checking details of a product, adding a product into a shopping cart, and purchasing a product.

The recommendation engine module may estimate at least one of gender, age, and area of interest of a user of the user terminal based on the log information and provide a plurality of recommended products in an order of the products having high relevance to the estimated information.

The landing page generation module may make the landing page to be provided to the shopping mall server by using API information or widget information.

The landing page generation module may generate landing page information in a form of program codes including a code set that makes the landing page to be generated by using the API information in the shopping mall server, and control the landing page information to be transmitted to the shopping mall server.

The landing page generation module may generate the landing page by using the widget information, generate landing page information in a form of program codes including a resource identifier capable of providing a link for a connection to the landing page, and control the landing page information to be transmitted to the shopping mall server.

According to an aspect of another exemplary embodiment, provided is a method of providing a user-customized landing page in a landing page providing server. The method includes: collecting log information including a behavioral pattern of a user terminal connected to a shopping mall server; analyzing the behavioral pattern of the user terminal by using collected log information and extracting recommended products suitable for the user terminal by using an analysis result; generating interface information for generating a landing page by using the recommended products; and generating landing page information suitable for the user terminal by using the interface information and transmitting the landing page information the shopping mall server.

The server and method according to the present disclosure analyzes the behavioral pattern of user terminals connected to the shopping mall server and provides the landing page suitable for each user by using the analysis result. Accordingly, the present disclosure induces interests of the users and increases a conversion rate while reducing the bounce rate.

Also, the present disclosure may cluster the users who have log information of a similar behavioral pattern. By grouping the users of the similar behavioral pattern, the present disclosure may optimize the number of cases resulting from the product recommendation into a number of clusters and can prevent the system overload.

In particular, since the customized landing page can be provided by collecting and analyzing the log information of the users having accessed the shopping mall server, and the collecting of the log information may be performed by simply inserting scripts and meta tags into the shopping mall pages, the present disclosure can enable an operator of a small shopping mall to provide a customized service.

In addition, the present disclosure can generate the landing page in real-time by combining products information matching the tendency of the user based on the products information collected from the shopping mall pages.

In order to provide a customized landing page based on the log information of the user terminals, the present disclosure collects information related to previous product purchase of the user and recommend products for each user. The customized landing page makes reliable and accurate product recommendation possible. In addition, since the product recommendation is provided based on the log information of the user terminal, the present disclosure improves the quality of the recommendation service and increases the conversion rate while lowering the bounce rate of the site. The present disclosure is industrially applicable because it can actually be implemented obviously and has a sufficiently high possibility of commercialization or sales.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram of a service providing system according to an exemplary embodiment of the present disclosure;

FIG. 2 is a block diagram of a user terminal according to an exemplary embodiment of the present disclosure;

FIG. 3 is a block diagram of a service providing server according to an exemplary embodiment of the present disclosure;

FIG. 4 is a flowchart illustrating a service providing method according to an exemplary embodiment of the present disclosure;

FIG. 5 is a flowchart depicting a signal flow between components of the service providing system when the service is provided based on API information according to an exemplary embodiment of the present disclosure;

FIG. 6 is a flowchart depicting a signal flow between components of the service providing system when the service is provided based on widget information according to an exemplary embodiment of the present disclosure;

FIG. 7 illustrates a screenshot of a conventional landing page of a online shopping mall; and

FIG. 8 illustrates a screenshot of a landing page of a online shopping mall provided by a service providing method according to an exemplary embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, the present disclosure will be described in detail with reference to the accompanied drawings.

In the following description and the accompanied drawings, detailed descriptions of well-known functions or configuration that may obscure the subject matter of the present disclosure will be omitted for simplicity. It is to be noted that the same components are designated by the same reference numerals throughout the drawings.

The terms and words used in the following description and drawings are not necessarily to be construed in an ordinary sense or a dictionary, and may be appropriately defined herein to be used as terms for describing the present disclosure in the best way possible. Such terms and words should be construed as meaning and concept consistent with the technical idea of the present disclosure.

The configurations of embodiments described in this specification or shown in the drawings are merely the most preferred embodiments of the present disclosure, and do not limit the technical ideas of the present disclosure. Therefore, it should be understood that there are various equivalents and modifications that may replace the configurations of the embodiments.

The terminologies including ordinals such as “first” and “second” used to explain various elements in this specification may be used to discriminate an element from the other ones or for simplicity. For example, a second component may be referred to as a first component, and similarly, a first component may also be referred to as a second component without departing from the scope of the present disclosure.

When an element is referred to as being “connected” or “coupled” to another element, it means that it is logically or physically connected or it may be connected to the other element. In other words, it is to be understood that although an element may be directly connected or coupled to another element, there may be other elements therebetween, or element may be indirectly connected or coupled to the other element.

The terminology used herein is for the purpose of describing particular embodiments only and is not intended to be limiting of the disclosure. The singular forms include plural referents unless the context clearly dictates otherwise. Also, The expressions “˜comprises,” “˜includes,” “˜constructed,” “˜configured” are not to be construed as being equipped with all the components, processing steps, or operations described in this specification, but some of the components, the processing steps, or the operations may not be included and additional elements may be incorporated further.

Terminologies such as “˜unit” and “˜module” refer to entities performing at least one function or operation, and may be implemented by hardware, software, or combination thereof.

In this specification, especially the claims, the articles “a,” “an,” and “the,” a cardinal number “one,” demonstrative pronouns, and the other demonstrative terminologies may designate singular or plural objects. Also, the expressions of the number of subjects or objects, especially the states, in this specification are not intended to limit the scope of the disclosure.

The embodiments within the scope of the present disclosure include computer-readable media having or carrying computer executable instructions or data structures stored in computer-readable media. Such computer-readable media may be an arbitrary media that is accessible by a general purpose or special purpose computer system. The computer-readable media may include, but is not limited to, a physical storage unit media such as RAM, ROM, EPROM, CD-ROM, other optical disk storage unit, a magnetic disk storage unit, and other magnetic storage unit devices. The computer-readable media may be used to store or deliver certain program code means in the form of computer-executable instructions, computer-readable instructions, or data structures.

Hereinbelow, a service providing server, a system, and a method of providing a customized landing page according to an embodiment of the present disclosure are described in detail with reference to attached drawings.

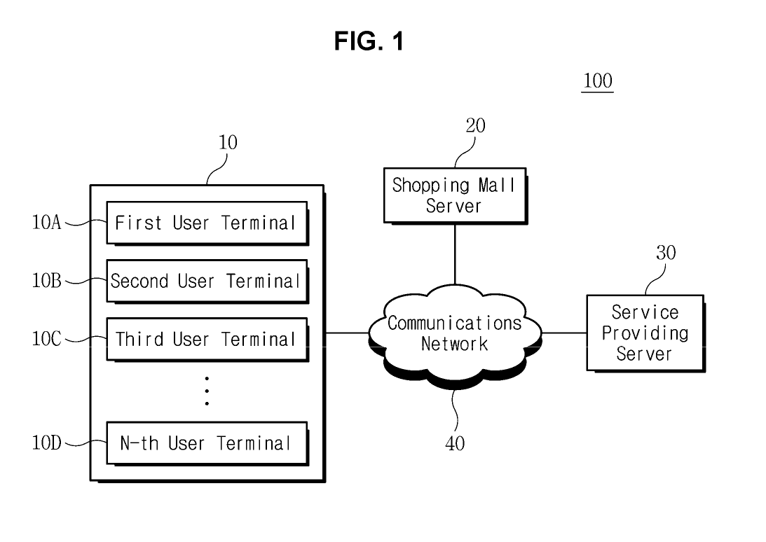

FIG. 1 is a block diagram of a service providing system according to an exemplary embodiment of the present disclosure.

Referring to FIG. 1, a service providing system 100 provides a landing page customized for each visitor or user to increase a conversion rate and lower a bounce rate of the site. The service providing system 100 can generate a real-time customized landing page, according to a request of an operator of the shopping mall, by analyzing a behavioral pattern of the user based on log information of a user terminal 10 connected to the shopping mall provided by a shopping mall server 20 and constructing the landing page by using an analysis result. In particular, the service providing system 100 may provide the landing page in-real time by collecting information on products provided by the shopping mall server 20 in real-time or periodically, extracting user-customized products among collected product information based on the analysis result, and combining the extracted products. The service providing system 100 may include the user terminal 10, a shopping mall server 20, and a landing page providing server 30 (hereinbelow, referred to as “service providing server”). Also, the service providing system 100 may include a communication network 40 connecting the user terminal 10, the shopping mall server 20, and the service providing server 30 to establish communications channels between them.

The communication network 40 may be composed of a backbone network and a subscriber network. The backbone network may include one of an X.25 network, a frame relay network, an ATM network, a Multiprotocol Label Switching (MPLS) network, and a Generalized Multiprotocol Label Switching (GMPLS) network, or a combination thereof. The subscriber network may include a fiber-to-the-home (FTTH) network, an asymmetric digital subscriber line (ADSL) network, a cable network, a Zigbee network, a bluetooth network, a wireless LAN based on, for example, IEEE 802.11b, IEEE 802.11a, or IEEE 802.11g standard, a), a wirelessHART network based on ISO/IEC62591-1 standard, an ISA100.11a (ISO/IEC62734) network, a Constrained Application Protocol (COAP) network, a Message Queuing Telemetry Transport (MQTT) network, a wireless broadband Internet (Wibro), a Worldwide Interoperability for Microwave Access (WiMAX) network, a 3G network, a High Speed Downlink Packet Access (HSDPA) network, a 4G network, or a next generation 5G network. In particular, the communication network 40 may be Internet or a mobile communications network.

The user terminal 10 is a terminal used by a user. In this specification including the appended claims, the term “user” is used as a synonym of “visitor.” The service providing system 100 may include a plurality of user terminals 10. For example, the plurality of user terminals 10 may include a first user terminal 10A, a second user terminal 10B, and a third user terminal 10C through an n-th user terminal 10D. Here, ‘n’ is a natural number greater than three. The plurality of user terminals 10 communicate with the shopping mall server 20 and the service providing server 30. Through the communicates with the shopping mall server 20 and the service providing server 30, each the plurality of user terminals 10 can perform searching product, checking details of a product, adding a product into a shopping cart, and purchasing a product, and may reveal at least one behavioral pattern. Also, in case of accessing the shopping mall server 20 through an advertisement banner or a search result page provided by a portal site, for example, the plurality of user terminals 10 may be provided with a landing page from the shopping mall server 20. At this time, the plurality of user terminals 10 can directly transmit the log information to the service providing server 30. Though the log information is used as an example of the information transmitted by the user terminal 10 to the service providing server 30, the present disclosure is not limited thereto and another information such as cookie information may be provided to the service providing server 30. The user terminal 10 may be any device as long as the device can access the shopping mall server 20 through the communication network 40 and receive and display a shopping mall page provided by the shopping mall server 20. For example, a smartphone, a desktop PC, a tablet PC, a laptop PC, a netbook, a handheld PC, or another type of mobile device may be used for the user terminal 10.

The shopping mall server 20, which is a merchant server operated by a shopping mall operator, may provide the user terminal 10 with products information and web pages for allowing user to purchase at least one of the products and perform transaction and payment processing of a selected product according to a request of the user terminal 10.

According to the present disclosure, the shopping mall operator may request the service providing server 30 to provide a customized landing page for the shopping mall provided by the shopping mall server 20.

After the operator of the service providing server 30 accepts a request of the shopping mall operator, a shopping mall page provided by the shopping mall server 20 may include a script and meta tag suitable for collecting product information related to the shopping mall page along with log information and transmitting collected product information and the log information to the service providing server 30 according to the present disclosure.

Accordingly, the shopping mall server 20 transmits the product information related to the shopping mall page and the log information of each user terminal 10 connected to the shopping mall page to the service providing server 30 in real-time or periodically. Here, the information transmitted by the shopping mall server 20 to the service providing server 30 is not limited to the log information, and another information such as cookie information may be transmitted to the service providing server 30.

In addition, the shopping mall server 20 may transmit needs information to the service providing server 30 so that the needs of the operator of the shopping mall server 20 is reflected before the service is initiated. Here, the needs information may include a desired type of the landing page in the shopping mall server 20, a preferred recommendation style, and the like. The shopping mall server 20 receives landing page information for a recommended product extracted for each user terminal 10 or the landing page from the service providing server 30 and provides the landing page to the terminal 10 based on the landing page information or the landing page received from the service providing server 30. The shopping mall server 20 can transmit at least one of a search advertisement, a banner advertisement, a keyword advertisement, an application push, and a notification message which facilitates a connection to the landing page for to each user terminal 10 to maximize effectiveness of marketing. The shopping mall server 20 may be implemented by a computer having a server class desktop PC, a server computer, or a cluster computer.

The service providing server 30 recommends a product suitable for each user terminal 10 based on the log information of the user terminal 10 for connections to the shopping mall server 20 and generates the landing page information for the recommended product to provide to the shopping mall server 20. In detail, the service providing server 30 directly collects the log information including the behavioral pattern of the user terminal 10 connected to the shopping mall server 20 from the user terminal 10. The service providing server 30 analyzes the behavioral pattern of each user terminal 10 by using the log information, and recommends the product suitable for each user terminal 10 based on the analysis result. Also, The service providing server 30 generates interface information for the recommended product. The service providing server 30 generates the landing page information for each user terminal 10 by using the interface information and transmits the generated landing page information to the shopping mall server 20. The service providing server 20 may be implemented by a computer having a server class desktop PC, a server computer, or a cluster computer.

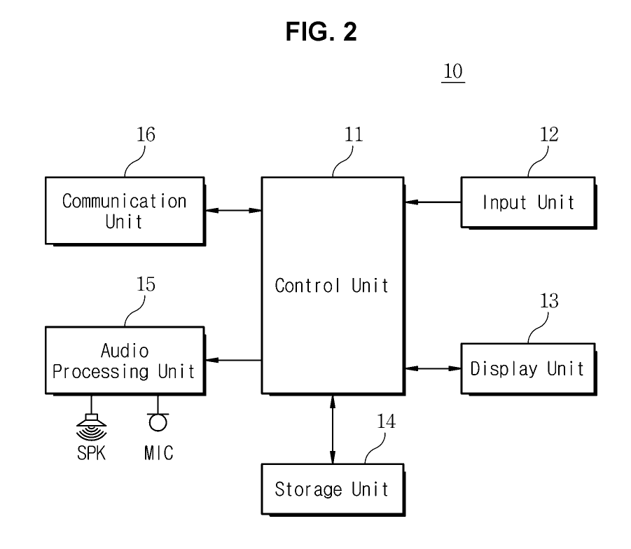

FIG. 2 is a block diagram of the user terminal 10 according to an exemplary embodiment of the present disclosure.

Referring to FIGS. 1 and 2, the user terminal 10 includes a control unit 11, an input unit 12, a display unit 13, a storage unit 14, an audio processing unit 15, and a communication unit 16.

The input unit 12 receives various information including numeric and character information and transfers a control signal corresponding to a control command for setting or controlling a function of the user terminal 10 to the control unit 11. The input unit 12 may include at least one of a keypad and a touchpad that generates an input signal according to a touch or manipulation of the user. Here, the input unit 12 and the display unit 13 may be incorporated into a single touch panel touch screen that performs both the input and output functions. Any type of input device that may be developed and available in the future in addition to a conventional input device such as a keyboard, the keypad, a mouse, a joystick, and the like may be used as the input unit 12. In particular, the input unit 12 may detect an input signal for selecting or purchasing a product to transmit a input detection signal to the control unit 11.

The display unit 13 may display information of a series of operating states and operation results during the operation of the user device 10. Also, the display unit 13 may display a menu of the user terminal 10 and the data input by the user. The display unit 160 may a liquid crystal display (LCD), a thin film transistor LCD (TFT-LCD), a light emitting diode (LED), an organic light emitting diode (OLED), an active-matrix organic light emitting diode (AMOLED), a retina display, a flexible display, or a three-dimensional display. When the display unit 13 is implemented in a form of the touch screen, the display unit 13 can perform some or all of the functions of the input unit 12. In particular, the display unit 13 may output product information related to a selection or purchase of the product. Also, the display unit 13 displays the landing page received from the shopping mall server 20.

The storage unit 14, which is device for storing data, includes a main storage unit device and an auxiliary storage unit device and stores application programs required for the functional operation of the user terminal 10. The storage unit 14 may include a program region and a data region. When the user terminal 10 activates a function in response to a request of the user, the user terminal 10 executes a corresponding application program under the control of the control unit 11 to perform the function. In particular, the storage unit 14 stores an operating system of the user terminal 10 and a program for providing an electronic commerce service of selecting or purchasing products. Also, the storage unit 14 stores the information on the recommended product and a user log related to the selection or purchase of products. The storage unit 14 may include at least one recording medium among a flash memory, a hard disk, a multimedia card micro, a card type memory such as a SD memory and a XD memory, a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The audio processor 15 converts an analog audio signal detected by a microphone MIC into a digital audio signal to transmit to the control unit 11. Also, the audio processing unit 15 may convert a digital output from by control unit 11 into an analog signal and to output through a speaker SPK. In particular, the audio processing unit 15 outputs an effect sound or the execution sound of the application program executed by the user terminal 10.

The communication unit 16 provides the user terminal 10 with a function of connecting to the communication network 40 to transmit and receive data and allows the user terminal 10 to access the shopping mall server 30. The communication unit 16 may include a RF transmitter that up-converts a frequency band of a transmitted signal and amplifies the transmitted signal and a RF receiver that amplifies a received signal and down-converts a frequency band of the received signal. The communication unit 16 may include at least one of a wireless communication module and a wired communication module.

The wireless communication module communicates with the shopping mall server 20 by a wireless communication scheme. The wireless communication module may include at least one of a wireless network communication module, a wireless LAN communication module, and a wireless personal area network (PAN) communication module. The wired communication module communicates with the shopping mall server 20 through a wired communication channel. In particular, the communication unit 16 may communicate with the user terminal 10 and the shopping mall server 20 to transmit and receive information required for providing the user-customized landing page.

The control unit 11 controls each component and functions of the user terminal 10 and may include a processing device such as a microprocessor. The processing module may perform a predetermined function by loading and executing a program stored in the storage unit 14 such as the RAM or the ROM. The program may include an operating system (OS) and an application program. Thus, the control unit 11 in the present disclosure may refer to a combination of the processing device and the program such as the OS and the application program. The control unit 11 may perform a predetermined function by executing the OS program to construct a runtime environment and executing one or more application programs based on the OS according to a request of the user or a prescribed setting. Particularly, according to the present disclosure, the control unit 11 controls the user terminal 10 to be connected to the shopping mall server 20 and receive and output the shopping mall page provided by the shopping mall server 20. Also, the control unit 11 may detect a user input for an event such as searching a product, checking details of a product, adding a product into the shopping cart, and purchasing a product, and transmit information of the product to the service providing server 30 according to the detected event.

In addition, according to the present disclosure, when the user terminal 10 is connected to the shopping mall server 20 via a certain search page or an advertisement page, the control unit 11 may receive the user-customized landing page from the shopping mall server 20 or the service providing server 30 and output through the display unit 13.

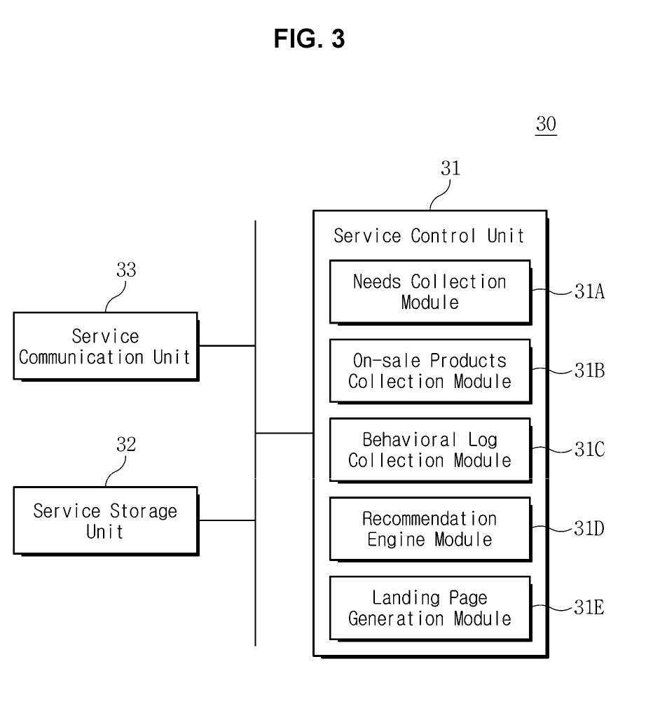

FIG. 3 is a block diagram of the service providing server 30 according to an exemplary embodiment of the present disclosure.

Referring to FIGS. 1 and 3, the service providing server 30 may include a service control unit 31, a service storage unit 32 and a service communication unit 33.

The service communication unit 33 communicates with the user terminal 10 and the shopping mall server 20 through the communication network 40 to transmit and receive information required for providing the customized landing page.

The service storage unit 32 stores all the programs required for implementing the functions of the service providing server 30. For example, the service storage unit 32 may store a program module for collecting the log information related to the selection or purchase of the product of each user terminal, a program module for sorting collected log information, a program module for extracting a recommended product for each user terminal based on the sorted log information, and a program module for generating the landing page information by using the recommended product information. In addition, the service storage unit 32 may store information collected, calculated, or generated by the program modules. For example, the service storage unit 32 may store needs information, log information, on-sale products information, recommended products information, landing page information, and the like. The service storage unit 32 may include at least one recording medium among the flash memory, a hard disk, a multimedia card micro, a card type memory such as a SD memory and a XD memory, a RAM, a SRAM, a ROM, an EEPROM, a PROM, a magnetic memory, a magnetic disk, and an optical disk.

The service control unit 31 controls services such that the landing page customized for each user terminal 10 can be provided to a corresponding user terminal 10. To this end, the service control unit 31 may include a processing device such as a microprocessor, which may perform a predetermined function by loading and executing a program stored in the service storage unit 32. The service control unit 31 may include a behavioral log collection module 31C, a recommendation engine module 31D, and a landing page generation module 31E. The service control unit 31 may further include a needs collection module 31A and an on-sale products collection module 31B.

The needs collection module 31A provides a landing page customized to each user terminal 10 to the shopping mall server 20 and collects the needs of the shopping mall server 20 having requested the service. The needs collection module 31A may collect the needs of the shopping mall server 20 when the service is first initiated, and may update the needs whenever the needs is changed. Here, the needs information may include a shape of the landing page and a recommendation style preferred by the shopping mall server 20.

The on-sale product products collection module 31B collects information on products sold by the shopping mall server 20 in real-time or periodically. The collection of the information on the products may be performed by using the meta tags inserted in each page provided by the shopping mall server 20. Preferably, a period for the collecting the products information may be about one week, but the present disclosure is not limited thereto.

The behavioral log collection module 31C collects log information of the user terminal 10 connected to the shopping mall server 20 including the behavioral pattern of the user or the user terminal 10. The behavior log collection module 31C may collect the log information including at least one behavioral pattern of searching a product, checking details of a product, adding a product into the shopping cart, and purchasing a product directly from the user terminal 10. Here, the behavioral log collection module 31C may collect the log information by using the cookie information of a browser.

If there is a common header file, the behavioral log collection module 31C may collect the log information by inserting a log collecting script for the common header and then inserting a ‘sendLog’ command in each page in case that there is a common header file while inserting a log collecting script including the the ‘sendLog’ command in each page in case that there is not the common header file. Preferably, the behavior log collection module 31C may collect up to about 90 days of recent log information and sort the collected log information. Also, the behavioral log collection module 31C may cluster the user terminals into groups having the log information of a similar behavioral pattern. Accordingly, it is possible to prevent a system overload by optimizing a number of cases resulting from the product recommendation into a number of clusters.

The recommendation engine module 31D analyzes the behavioral pattern of each user terminal 10 by using the collected log information and extracts recommended products suitable for each user terminal 10 by using the analysis result. The recommendation engine module 31D may estimate at least one of the user's gender, age, and area of interest by using the log information and extract a plurality of recommended products in an order of the products having high relevance to the estimated information. For example, if the log information of the first user terminal 10A includes information such as an one-piece dress, shoes, a latest product list, and the like, the recommendation engine module 31D may estimate that the user of the first user terminal 10A is a woman in her 30s or 40s and is interested in fashion and extracts the recommended products the order of products having high relevance with the estimated information. At this time, when the log information includes a history of checking products, the shopping cart, or the product purchases, the recommendation engine module 31D may analyze the styles of the products and extracts the recommended products in the order of products having high relevance with a style analysis result.

The landing page generation module 31E controls a process of providing the landing page to the shopping mall server 20 using the extracted recommended products. The landing page generation module 31E can control the landing page to be delivered to the shopping mall server 20 by Application Programming Interface (API) information or widget information. In an exemplary embodiment, either the API information or the widget information may be selected according to a desired form by the shopping mall server 20 designated by the needs information.

When the API information is used for a delivery of the landing page, the landing page generation module 31E may generate landing page information in a form of a source code including a subroutine or a function facilitating the generation of the landing page in the shopping mall server 20. The landing page generation module 31E controls the landing page information to be transmitted to the shopping mall server 20 so that the shopping mall server 20 can generate the landing page through the source code of the landing page information.

When the widget information is used for the delivery of the landing page, the landing page generation module 31E may generate the landing page by using the widget information. The landing page generation module 31E may generate the landing page information in a form of a source code including a unified resource identifier (URI) capable of providing a link for a connection to the generated landing page, and control the generated landing page information to be transmitted to the shopping mall server 20. In addition, the landing page generation module 31E can control the generated landing page to be directly transferred to the shopping mall server 20. That is, the shopping mall server 20 can access the URI included in the landing page information to receive the landing page, or can directly receive the landing page.

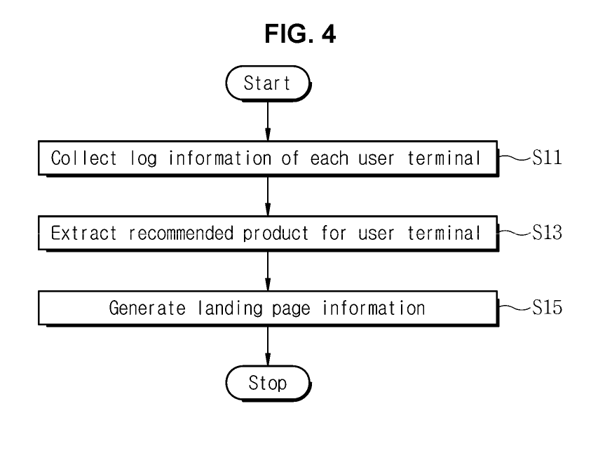

FIG. 4 is a flowchart illustrating a service providing method according to an exemplary embodiment of the present disclosure.

Referring to FIGS. 1 and 4, the service providing method according to the present disclosure analyzes the behavioral pattern of user terminals connected to the shopping mall server 20 and provides the landing page suitable for each user by using the analysis result. Accordingly, the present disclosure induces interests of the users and increases a conversion rate while lowering the bounce rate. Also, the service providing method may cluster the users who have log information of a similar behavioral pattern, thereby optimizing the number of cases resulting from the product recommendation into a number of clusters and preventing the system overload in advance. In particular, the service providing method according to the present disclosure can enable an operator of a small shopping mall to provide a customized service. In addition, the service providing method of the present disclosure allows to be provide the landing page in real-time by combining products that matches the user's tendency based on the product information collected from the shopping mall page of the shopping mall operator.

In operation S11, the service providing server 30 collects the log information including the behavioral pattern of the user terminal 10 connected to the shopping mall server 20. The service providing server 30 may collect the log information including at least one behavioral pattern of searching a product, checking details of a product, adding a product into the shopping cart, and purchasing a product directly from the user terminal 10. Here, service providing server 30 may collect the log information by using the cookie information of the browser. Preferably, the service providing server 30 may collect up to about 90 days of recent log information and sort the collected log information. Also, the service providing server 30 may cluster the user terminals having the log information of a similar behavioral pattern into a same group. Accordingly, it is possible to prevent a system overload by optimizing a number of cases resulting from the product recommendation into a number of clusters.

The service providing server 30 may collect the needs information of the shopping mall server 20 to provide the landing page customized for each user terminal 10 to the shopping mall server 20. The needs collection module 31A may collect the needs of the shopping mall server 20 when the service is first initiated, and may update the needs whenever the needs is changed. Also, the service providing server 30 may collect the information on products sold by the shopping mall server 20 in real-time or periodically. The period for collecting the products information may be about one week, but the present disclosure is not limited thereto.

In operation S13, the service providing server 30 analyzes the behavioral pattern of each user terminal 10 using the collected log information and extracts recommended products suitable for each user terminal 10 by using the analysis result. The service providing server 30 may estimate at least one of the user's gender, age, and area of interest by using the log information and extract a plurality of recommended products in an order of the products having high relevance to the estimated information. At this time, when the log information includes a history of checking products, the shopping cart, or the product purchases, the service providing server 30 may analyze the styles of the products and extracts the recommended products in the order of products having high relevance with a style analysis result.

In operation S15, the service providing server 30 enables the process of providing the landing page to the shopping mall server 20 using the extracted recommended products. The service providing server 30 can make the landing page to be delivered to the shopping mall server 20 by Application Programming Interface (API) information or widget information.

When the API information is used for a delivery of the landing page, the service providing server 30 may generate landing page information in a form of a source code including a subroutine or a function facilitating the generation of the landing page in the shopping mall server 20. The service providing server 30 transmits the landing page information to the shopping mall server 20 so that the shopping mall server 20 can generate the landing page through the source code of the landing page information.

When the widget information is used for the delivery of the landing page, the service providing server 30 may generate the landing page by using the widget information. The service providing server 30 may generate the landing page information in a form of a source code including a unified resource identifier (URI) capable of providing a link for a connection to the generated landing page, and make the generated landing page information to the transmitted to the shopping mall server 20. In addition, the service providing server 30 can directly transmit the generated landing page to the shopping mall server 20. Thus, the shopping mall server 20 can access the URI included in the landing page information to receive the landing page, or can directly receive the landing page.

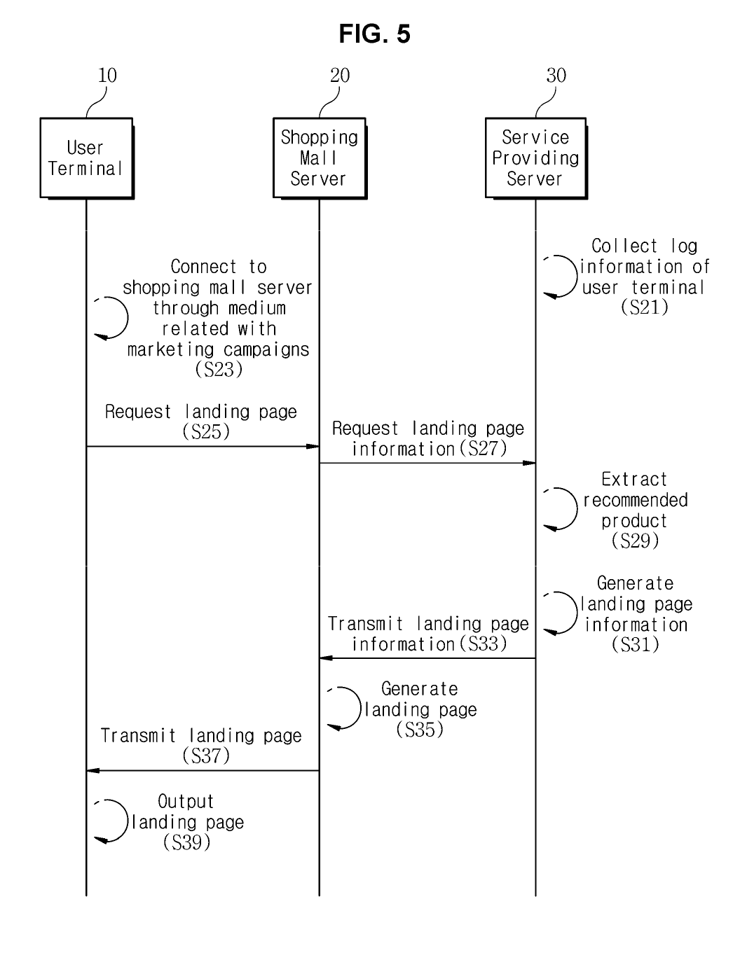

FIG. 5 is a flowchart depicting a signal flow between components of the service providing system 100 when the service is provided based on API information according to an exemplary embodiment of the present disclosure.

Referring to FIG. 5, the service providing method may provide a user-customized landing page by using the API information.

In operation S21, the service providing server 30 may collect the log information of the user terminal 10 connected to the shopping mall server 20. The service providing server 30 may collect the log information including at least one behavioral pattern of searching a product, checking details of a product, adding a product into the shopping cart, and purchasing a product directly from the user terminal 10. Here, service providing server 30 may collect the log information by using the cookie information of the browser.

In operation S23, the user terminal 10 may access the shopping mall server 20 through one of lots of media provided by various marketing campaigns, web pages of a portal site, and the like. Here, the marketing campaigns include a online advertisement, a text, an email, a notifications message, and a mobile application push.

In operation S25, the user terminal 10 may request a landing page suitable for the user terminal 10 from the shopping mall server 20.

In operation S27, the shopping mall server 20 may request the landing page information from the service providing server 30. At this time, the shopping mall server 20 can request the landing page information generated by using the API information.

In operation S29, the service providing server 30 may extract recommended products suitable for the user terminal 10. The service providing server 30 may analyze the behavioral pattern of each user terminal 10 by using the collected log information and extract the recommended products suitable for each user terminal 10 by using the analysis result. The service providing server 30 may estimate at least one of the user's gender, age, and area of interest by using the log information and extract a plurality of recommended products in an order of the products having high relevance to the estimated information.

In operation S31, the service providing server 30 generates the landing page information by using the extracted recommended products. The service providing server 30 may generate the landing page information in the source code including a subroutine or a function facilitating the generation of the landing page in the shopping mall server 20.

In operation S33, the service providing server 30 transmits the landing page information to the shopping mall server 20.

In operation S35, the shopping mall server 20 generates the landing page by using the received landing page information. In other words, the shopping mall server 20 generates the user-customized landing page according to a predetermined web page configuration by using the recommended products included in the landing page information.

In operation S37, the shopping mall server 20 transmits the landing page to the user terminal 10.

In operation S39, the user terminal 10 outputs the received landing page.

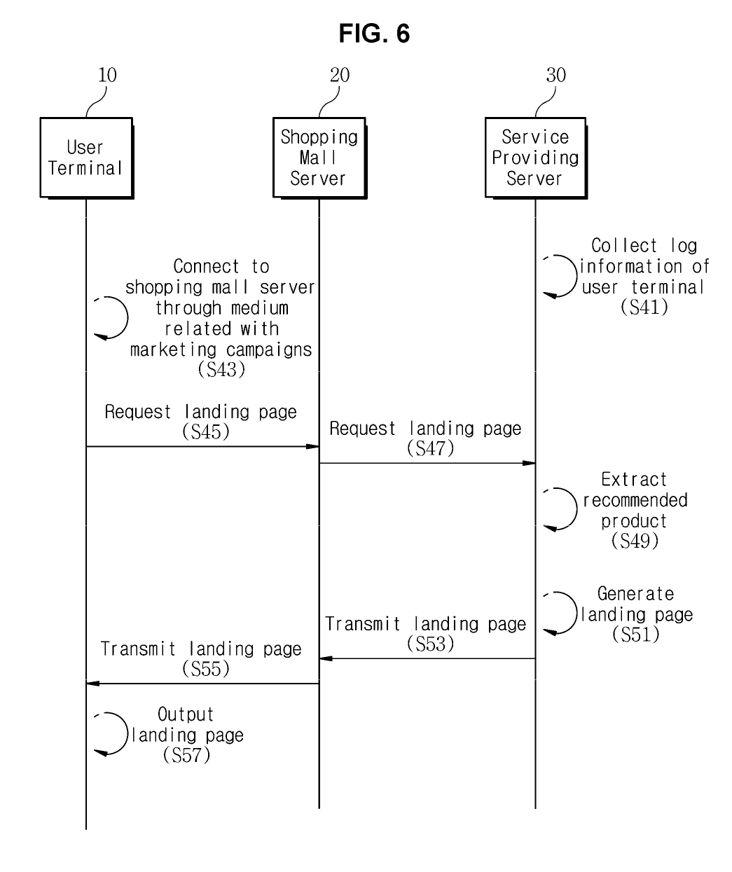

FIG. 6 is a flowchart depicting a signal flow between components of the service providing system 100 when the service is provided based on widget information according to an exemplary embodiment of the present disclosure.

Referring to FIG. 6, the service providing method may provide the customized landing page by using the widget information.

In operation S41, the service providing server 30 may collect the log information of the user terminal 10 connected to the shopping mall server 20. The service providing server 30 may collect the log information including at least one behavioral pattern of searching a product, checking details of a product, adding a product into the shopping cart, and purchasing a product directly from the user terminal 10. Here, service providing server 30 may collect the log information by using the cookie information of the browser.

In operation S43, the user terminal 10 may access the shopping mall server 20 through one of lots of media provided by various marketing campaigns, web pages of a portal site, and the like. Here, the marketing campaigns include a online advertisement, a text, an email, a notifications message, and a mobile application push.

In operation S45, the user terminal 10 may request a landing page suitable for the user terminal 10 from the shopping mall server 20.

In operation S47, the shopping mall server 20 may request the landing page information from the service providing server 30. At this time, the shopping mall server 20 can request the landing page information generated by using the widget information.

In operation S49, the service providing server 30 may extract recommended products suitable for the user terminal 10. The service providing server 30 may analyze the behavioral pattern of each user terminal 10 by using the collected log information and extract the recommended products suitable for each user terminal 10 by using the analysis result. The service providing server 30 may estimate at least one of the user's gender, age, and area of interest by using the log information and extract a plurality of recommended products in an order of the products having high relevance to the estimated information.

In operation S51, the service providing server 30 generates the landing page by using the extracted recommended products. The service providing server 30 may generate the customized landing page for the recommended product by using the widget information.

In operation S53, the service providing server 30 provides the landing page to the shopping mall server 20.

In operation S55, the shopping mall server 20 transmits the landing page to the user terminal 10.

In operation S57, the user terminal 10 outputs the received landing page.

Meanwhile, when the shopping mall server 20 requests the landing page information associated with the landing page, the service providing server 30 may further generate the landing page information by using the source code including the URI providing a connection to the landing page, after the operation S51, to transmit the generated landing page information to the shopping mall server 20.

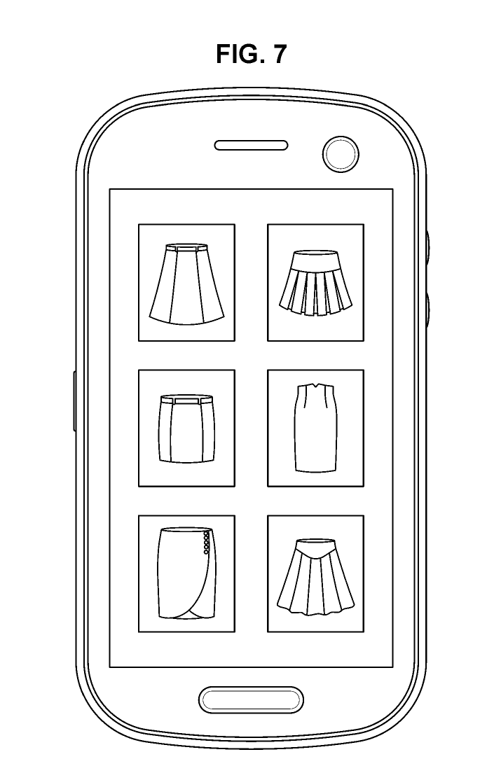

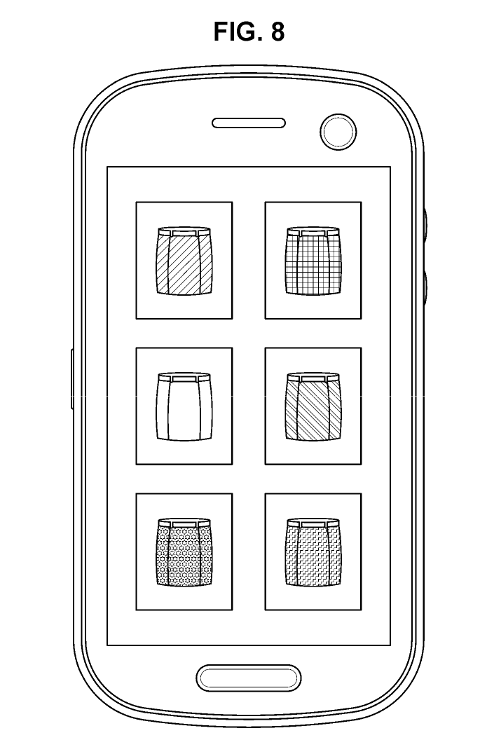

FIG. 7 illustrates a screenshot of a conventional landing page of a online shopping mall, and FIG. 8 illustrates a screenshot of a landing page of a online shopping mall provided by a service providing method according to an exemplary embodiment of the present disclosure.

Referring to FIGS. 7 and 8, the service providing method provides a landing page suitable for a user who uses the user terminal 10, rather than a conventional method of constructing a landing page, to minimize a conversion rate and a dropout rate of a site can do. The service providing method can provide the landing page to the user using various marketing campaigns.

The service providing method can provide a landing page using a mobile application push, a keyword/banner advertisement, a notification call, and the like. Hereinafter, an embodiment in which a service providing method is utilized will be described.

The landing page may be provided through the mobile application push as follows.

In general, most of the apps in the mall are implemented in hybrid form, often used by loyal customers, and send app pushes for marketing purposes. Usually, a push is sent according to various events or new products receipt. In this case, the landing page of the app push is a single page which is not personalized. On the other hand, when the application push method of the present disclosure is applied, the user experiences a landing page composed of recommendation items personalized for each user. However, the user who has been connected to the shopping mall for a predetermined period of time or who is first connected can receive the landing page as a real-time product, rather than a real-time user-recommended product. Here, the predetermined period may be about 90 days, but is not limited thereto.

For example, when an app push for a ‘skirt’ is dispatched, a landing page resulting from a conventional app push provides a product designed by the shop operator. However, when an app push is applied, the landing page is created by referring to the previous behavioral pattern of the user. That is, if there is a history that the user has previously confirmed the product on the skirt, added the shopping cart, and purchased, the characteristic of the skirt corresponding to the history is analyzed, and the landing page is generated using the analyzed result. If the user has a history of purchasing a skirt having no pattern, a single color, and a short length, the present disclosure can provide a landing page in the order of a recommendation item having a similarity to the skirt using the log information.

The landing page may be provided through the keyword advertisement or the banner advertisement as follows.

When a search ad is executed, keywords and landing pages may be in the same context, but sometimes not. For example, if you search for the keyword ‘skirt’ and connect to the shopping mall through search ads, a landing page with most of the skirt categories is set. However, since the keyword ‘female apparel shopping mall’ does not have a page matching the keyword context, the main page or the product category page is set as the landing page. Applying the service providing method of the present disclosure to the keyword of such a pattern can contribute to the decrease of the dropout rate and the increase of the stay time.

Also, when executing the banner advertisement of the portal site, most existing landing pages are set only for the main page, the product category page, and the like. However, by applying the service providing method of the present disclosure, it is possible to construct a user-customized landing page in real time and reduce the drop-out rate.

The landing page may be provided through the notification message as follows.

In general, shopping malls utilize notification message services provided by SNS service providers as an extended version of a conventional short message for customer consultation, various guidance, and the other notifications for marketing purposes.

For example, KakaoTalk (Trademark of Kakao Corp.) allows a transmission of messages for marketing purposes to another user. At this time, since the service providing method of the present disclosure is applied to most of the users who shop at the corresponding shopping mall, it is possible to reduce the bounce rate and increase the conversion rate by providing customized products for each user.

Hereinbelow, provided is a performance evaluation of the customized landing page providing method of the present disclosure through a comparison with a general landing page providing method.

### EXAMPLE 1

### Comparison with Mobile Keyword Advertisement of Company ‘A’

TABLE 1

| | Advertisement | Number of | Conversion | Convesion | |
|---|---|---|---|---|---|
| Landing page | expense | conversion | rate | Revenue | ROAS |
| Conventional, | 3,143,580 | 90 | 1.83% | 7,141,500 | 227.18% |
| in main page | | | | | |
| Present | 3,127,900 | 113 | 2.28% | 9,317,780 | 297.89% |
| disclosure | | | | | |

A first comparative experiment was carried out in a same shopping mall for 2 weeks by changing only the method of providing the landing page.

In a first week, advertisements were provided through a landing page, which was the main page, generated by a conventional method. In a second week, the advertisements were provided through a landing page generated according to the present disclosure.

It can be seen in Table 1 that the present disclosure increases the conversion rate by 24% and a return on ad spend (ROAS) ratio by 31% compared with a case where the main page is provided as the landing page in the same keyword.

### EXAMPLE 2

### Comparison with Mobile Banner Advertisement of Company ‘B’

TABLE 2

| | Advertising | | Number of page |
|---|---|---|---|
| Landing pages | expenses | Bounce rate | views per session |
| Conventional | 48,448 | 74.69% | 1.95 |
| (in main page) | | | |
| Present disclosure | 42,528 | 68.10% | 2.33 |

A second comparative experiment was carried out in a same shopping mall for 2 weeks by changing only the method of providing the landing page. In a first week, advertisements were provided through a landing page generated by a conventional method. In a second week, the advertisements were provided through a landing page generated according to the present disclosure.

It can be seen in Table 2 that the present disclosure lowers the bounce rate by 9% while increasing a number of page views per session by 20% compared with a case where a main page is provided as the landing page in the same keyword.

The present disclosure can also be implemented by computer-readable codes stored in on a computer-readable recording medium. The computer-readable recording medium includes all kinds of recording devices which stores data that can be read out by a computer device. Examples of the computer-readable recording medium include a hard disk, a ROM, a RAM, a CD-ROM, a magnetic tape, a floppy disk, an optical data storage device. Also, the present disclosure can be implemented based on a carrier wave which may be related to a transmission through Internet.

While the present specification contains a number of specific implementation details, it should be understood that they are not to be construed as limitations on the scope of any disclosure or claims, but as a description of features that may be specific to a particular embodiment of a particular disclosure. Certain features described with respect to contexts of independent embodiments may be implemented in combination in a single embodiment. Conversely, various features described in the context of a single embodiment may also be implemented in other embodiments either individually or in any suitable sub-combination. Further, although some features may be described to operate in a particular combination and may be initially depicted as so claimed, one or more features from the claimed combination may in some cases be excluded from the combination, and a claimed combination may be replaced by a sub-combination or a variant of the sub-combination.

Similarly, although the operations are depicted in the drawings in a particular order, it should not be understood that such operations need to be performed in that particular order or sequential order shown to achieve the desired result or all the depicted operations should be performed. In certain cases, multitasking and parallel processing may be advantageous. Also, The fragmentation of the various system components in the above-described embodiments should not be understood as requiring such fragmentation in all embodiments, and the program components and systems described above may generally be integrated together into a single software product or packaged into a multiple-function software product.

Although specific embodiments of the subject matter have been described herein, other embodiments are within the scope of the following claims. For example, the operations defined in the claims may be performed in a different order to still achieve desirable results. By way of example, the process illustrated in the accompanied drawings does not necessarily require that particularly illustrated sequence or sequential order to achieve the desired result. In certain implementations, multitasking and parallel processing may be advantageous.

The descriptions set forth above disclose the best mode of the present disclosure, and is provided to illustrate the disclosure and to enable those skilled in the art to make and use the disclosure. The written description is not intended to limit the disclosure to the specific terminology presented. Thus, although the present disclosure has been described in detail with reference to the above examples, those skilled in the art will be able to make adaptations, modifications, and variations on the examples without departing from the scope of the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A landing page providing server suitable for providing a user-customized landing page, comprising:
a behavioral log collection module configured to collect log information including a behavioral pattern of a user terminal connected to a shopping mall server;
a recommendation engine module configured to analyze the behavioral pattern of the user terminal by using the log information collected by the behavioral log collection module and extracts recommended products suitable for the user terminal by using an analysis result; and
a landing page generation module configured to make a landing page suitable for the user terminal to be generated based on the recommended products extracted by the recommendation engine module and to be provided to the shopping mall server.

2. The landing page providing server of claim 1, further comprising:
an on-sale products collection module configured to collect information on products sold by the shopping mall server in real-time or periodically.

3. The landing page providing server of claim 1, wherein the behavioral log collection module collects, from the user terminal, the log information including at least one of behavioral patterns including: searching a product, checking details of a product, adding a product into a shopping cart, and purchasing a product.

4. The landing page providing server of claim 1, wherein the recommendation engine module estimates at least one of gender, age, and area of interest of a user of the user terminal based on the log information and provides a plurality of recommended products in an order of the products having high relevance to the estimated information.

5. The landing page providing server of claim 1, wherein the landing page generation module makes the landing page to be provided to the shopping mall server by using API information or widget information.

6. The landing page providing server of claim 5, wherein the landing page generation module generates landing page information in a form of program codes including a code set that makes the landing page to be generated by using the API information in the shopping mall server, and controls the landing page information to be transmitted to the shopping mall server.

7. The landing page providing server of claim 5, wherein the landing page generation module generates the landing page by using the widget information, generates landing page information in a form of program codes including a resource identifier capable of providing a link for a connection to the landing page, and controls the landing page information to be transmitted to the shopping mall server.

8. A method of providing a user-customized landing page in a landing page providing server, comprising:
collecting log information including a behavioral pattern of a user terminal connected to a shopping mall server;
analyzing the behavioral pattern of the user terminal by using collected log information and extracting recommended products suitable for the user terminal by using an analysis result;
generating interface information for generating a landing page by using the recommended products; and
generating landing page information suitable for the user terminal by using the interface information and transmitting the landing page information the shopping mall server.
